(19) United States
(12) Patent Application Publication
(10) Pub. No.: US 2025/0155272 A1
(43) Pub. Date: May 15, 2025

(54) METHOD AND SYSTEM OF PROOF TESTING ROLLOVER PROTECTION FUNCTIONALITY IN A TANK

(71) Applicant: Rosemount Tank Radar AB, Mölnlycke (SE)

(72) Inventors: Victoria Lund Mattsson, Lidköping (SE); Christian Swenson, Hultafors (SE); Christoffer Hoffmann, Hindås (SE); Ola Håll, Lerum (SE)

(21) Appl. No.: 18/922,694

(22) Filed: Oct. 22, 2024

(30) Foreign Application Priority Data
Nov. 15, 2023 (SE) 2351305-4

(51) Int. Cl. G01F 25/20; F17C 13/02

(52) U.S. Cl. CPC G01F 25/24; F17C 13/026; F17C 2201/0119; F17C 2201/032; F17C 2201/052; F17C 2221/033; F17C 2250/0417; F17C 2250/0439; F17C 2250/0491

(57) ABSTRACT

A method of proof testing a rollover detection system in a field device system includes a fill level sensor for determining a fill level of a product in a tank, and a sensor arrangement to determine at least one of temperature and density at multiple locations in the tank, the method includes: providing simulated temperature and/or density values for the sensor arrangement, the simulated temperature and/or density values being indicative of stratification of a product in the tank; acquiring a fill level of the product in the tank, and the simulated temperature and/or density values for the sensor arrangement, and providing the fill level, simulated temperature and/or density values to a rollover evaluation unit; and receiving, from the rollover evaluation unit, an output indicative of a risk of rollover in the tank from the fill level and the simulated temperature and/or density values.

### FIELD OF THE INVENTION

The present invention relates to a rollover protection method and system. In particular, the present invention is aimed at proof testing a rollover detection method and system in a tank.

### BACKGROUND OF THE INVENTION

Liquefied natural gas (LNG) can have different compositions depending on where the gas is sourced which gives it different characteristics. When gas from different sources is filled or mixed incorrectly in a storage tank, a phenomenon called stratification may occur due to differences in density and temperature. At a critical point when the composition of the stratified layers resembles each other, and near equilibrium, a rapid mixing will occur. This is known as a rollover incident. When a rollover occurs there is a large release of vapor which can damage or rupture the tank holding the gas, as well as emit large quantities of methane gas to the atmosphere.

In full containment storage tanks storing LNG, a system for rollover prediction (ROP) is required. Historically such a system has comprised a Level, Temperature and Density (LTD) device. The LTD device uses a probe to measure the fill level in the tank and to measure temperature and density at set interval points in the tank. These points are typically spaced 0.5-1.5 meters apart according to standards and guidelines. A measuring process is typically conducted once every 24 hours resulting in a profile. The profile measurement process for the LTD device typically takes 20-40 minutes depending on tank size and number of measurement points. From the measured data collected via the LTD device, indication of stratification can be witnessed. The stratification data is sent to a software which calculates and simulates the risk and magnitude of rollover, and the proper response can be initiated.

Accordingly, it is important to ensure that a functioning rollover protection system is in place in a tank storing LNG and it is thereby desirable to facilitate and enable the use of rollover protection systems.

### SUMMARY

In view of above-mentioned problems, it is an object of the present invention to provide a method and system for proof testing of a rollover-detection system in a field device system.

According to a first aspect of the invention, it is provided a method of proof testing a rollover detection system in a field device system comprising a fill level sensor for determining a fill level of a product in a tank, and a sensor arrangement configured to determine at least one of temperature and density at multiple locations in the tank, the method comprising: by a proof testing control unit, providing simulated temperature and/or density values for the sensor arrangement, the simulated temperature and/or density values being indicative of stratification of a product in the tank; by a system hub, acquiring a fill level of the product in the tank, and the simulated temperature and/or density values for the sensor arrangement, and providing the fill level, and the simulated temperature and/or density values to a rollover evaluation unit; and by the system hub, receiving, from the rollover evaluation unit, an output indicative of a risk of rollover in the tank resulting from the fill level and the simulated temperature and/or density values.

A field device should be understood to include any device that determines a process variable and communicates a measurement signal indicative of that process variable to a remote location. Examples of field devices include devices for determining process variables such as filling level, temperature, pressure, fluid flow etc. In the present disclosure, the field device system for example comprises field devices in the form of one or more fill level sensors, temperature sensors and/or density sensors.

The present invention is based on the realization that proof testing of a rollover detection system can be achieved by simulating temperature and/or density values for a sensor arrangement in a tank. The simulated temperature and/or density values can then be configured to represent stratification of liquefied natural gas (LNG) which in turn can be indicative of imminent rollover in the tank. Through the described method it is thereby possible to verify that a rollover detection system is functional without having to physically inspect or modify components of the tank. The rollover evaluation unit is also provided with level data from the fill level sensor.

In the present context, the proof testing control unit is responsible for providing temperature and/or density values for the LNG in the tank such that the temperature and/or density values are indicative of stratification in the tank. By using temperature and/or density values which are known to indicate a degree of stratification which could lead to rollover, it can be verified that the rollover evaluation unit provides the correct response warning of a rollover event. The values to use which are indicative of stratification can be based on empirical data, or they can be derived analytically based on known relations between temperature, density and stratification in an LNG tank. It is of course also possible to provide temperature and/or density values which do not indicate stratification to ensure that the response from the rollover evaluation is correct also for normal operating conditions.

The system hub here acts as a link between the sensor arrangement and the rollover evaluation unit, and the functionality of the system hub may vary depending on the application. For example, in a field device system operating in a plurality of tanks, additional intermediate hubs may be connected to a respective tank before being connected to the system hub. However, the described principle of simulating temperature and/or density values for proof testing the rollover evaluation unit is applicable also in larger systems comprising a plurality of tanks where a system in each tank may be tested and evaluated individually.

The rollover evaluation unit comprises software specifically dedicated to calculating the risk of rollover, and the output from the rollover evaluation unit may be in the form of a risk and magnitude of rollover, such as a number of days remaining until rollover can be expected. Details relating to how the rollover evaluation unit determines and evaluates the risk of rollover based on the described input data are known by the skilled person and will not be discussed in the present disclosure.

Various examples of the described invention thereby provide a simple, fast and cost-efficient way of proof testing a critical safety system of LNG tanks.

According to an example embodiment, the sensor arrangement comprises a plurality of temperature sensors spaced apart in the tank. The temperature sensors are distributed to detect and indicate if stratification occur in the tank.

According to an example embodiment, providing simulated temperature values indicative of stratification of a product in the tank comprises, by the proof testing control unit, providing a simulated temperature value to each of the plurality of temperature sensors; and by the system hub, acquiring the simulated temperature values from the plurality of temperature sensors. By providing the simulated temperature values directly to the temperature sensors, the functionality of the full communication path, from the temperature sensors to the system hub and further on to the rollover evaluation unit can be verified. It can thereby be detected if there is a fault in a temperature sensor or in the communication between the different components in the field device system.

According to an example embodiment the method may further comprise controlling each temperature sensor to only send a simulated temperature value to the system hub. The temperature sensor will thus not send a measured temperature value, and the system hub can be configured to operate in a normal operation mode also during the proof testing method.

According to an example embodiment, providing simulated temperature values indicative of stratification of a product in the tank may comprise, by the proof testing control unit, sending simulated temperature values for the plurality of temperature sensors to the system hub. By providing simulated temperature values directly to the system hub, the temperature sensors can be entirely bypassed. This may be advantageous in situations where it is desirable to only proof test the rollover evaluation unit as such, and/or a communication path between the system hub and the rollover evaluation unit.

According to an example embodiment, the method may further comprise setting the field device system in a simulation mode. The field device system or selected components of the field device system can then be made aware of that a simulation is ongoing where temperature and/or density values in different parts of the system do not necessarily correspond to actual measured values. The use of a simulation mode may be advantageous to avoid that other alerts or the like are triggered during simulation.

According to an example embodiment, the method may further comprise determining a level of the product in the tank; determining which of the plurality of temperature sensors are located in the product; and setting temperature values indicative of stratification in the tank for the temperature sensors located in the product.

According to an example embodiment, the method further comprises, by a pressure sensor arranged in the tank, determining a pressure in the tank and providing the determined pressure to the rollover evaluation unit. In some applications, the risk of rollover can me more accurately determined taking the pressure into account, or the rollover evaluation unit may require a measurement of the pressure.

According to an example embodiment, the sensor arrangement comprises an LTD (Level Temperature Density) profiling sensor. The LTD sensor can thereby measure the density at different locations in the tank to determine a density profile in the tank. Consequently, density values from the LTD sensor can be simulated and provided at various locations and to different units in the field device system as previously described.

There is also provided a computer program product comprising program code for performing, when executed by a processor device, the method of any of the aforementioned embodiments, a control system comprising one or more control units configured to perform the method and a non-transitory computer-readable storage medium comprising instructions, which when executed by the processor device, cause the processor device to perform the method of any of the aforementioned embodiments.

According to a second aspect of the invention, there is provided a field device system comprising: a fill level sensor configured to determine a fill level of a product in a tank; a sensor arrangement arranged to determine at least one of a temperature and a density at multiple locations in the tank; a proof testing control unit configured to provide simulated temperature and/or density values for the sensor arrangement, the simulated temperature and/or density values being indicative of stratification of the product in the tank; and a system hub configured to: acquire a fill level of the product in the tank and the simulated temperature and/or density values for the sensor arrangement, provide the fill level and the simulated temperature and/or density values to a rollover evaluation unit; and receive, from the rollover evaluation unit, an output indicative of a risk of rollover in the tank based on the fill level, and the simulated temperature and/or density values.

According to an example embodiment, the sensor arrangement comprises a plurality of temperature sensors spaced apart in the tank, thereby enabling determination of a temperature profile in the tank. According to an example embodiment, the plurality of temperature sensors are arranged on a probe and distributed along the length of the probe. Preferably, a vertical distance between adjacent temperature sensors is lower than or equal to 1 meter to ensure sufficient resolution in order to be able to correctly evaluate the risk of rollover in the tank. In some embodiments, the temperature sensors may be arranged on a wall of the tank or on other structures in the tank.

According to an example embodiment, the proof testing control unit is configured to provide simulated temperature values to the plurality of temperature sensors, and the system hub is further configured to acquire the simulated temperature values from the plurality of temperature sensors.

According to an example embodiment, the proof testing control unit is configured to send simulated temperature values for the plurality of temperature sensors to the system hub.

According to an example embodiment, the fill level sensor is configured to perform a level measurement to determine a level of the product in the tank; and wherein the proof testing unit is configured to determine which of the plurality of temperature sensors are located in the product, and to set temperature values indicative of stratification in the tank for the temperature sensors located in the product.

According to an example embodiment, the plurality of temperature sensors are arranged on a probe and distributed along the length of the probe.

According to an example embodiment, the field device system according further comprises a pressure sensor arranged in the tank, the pressure sensor being configured to determine a pressure in the tank and to provide the determined pressure to the rollover evaluation unit.

According to an example embodiment, the sensor arrangement comprises an LTD (Level Temperature Density) profiling sensor.

Further effects and features of the second aspect of the invention are largely analogous to those described above in connection with the first aspect of the invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIG. 1 schematically illustrates an exemplary field device system in the form of a radar level gauge system;

FIG. 2 is a schematic block diagram of a field device system according to an embodiment of the invention;

FIG. 3 schematically illustrates an exemplary tank arrangement comprising a field device system according to an embodiment of the present invention; and

FIG. 4 is a flow chart outlining steps of a method according to an example embodiment of the invention.

### DETAILED DESCRIPTION OF EXAMPLE EMBODIMENTS

In the present detailed description, various embodiments of the field device system and method of proof testing a rollover detection system in the field device system are mainly described with reference to a field device system arranged to determine the level of LNG in a stationary tank. However, the described system and method is equally suitable in other applications, such as in ship-based LNG tanks.

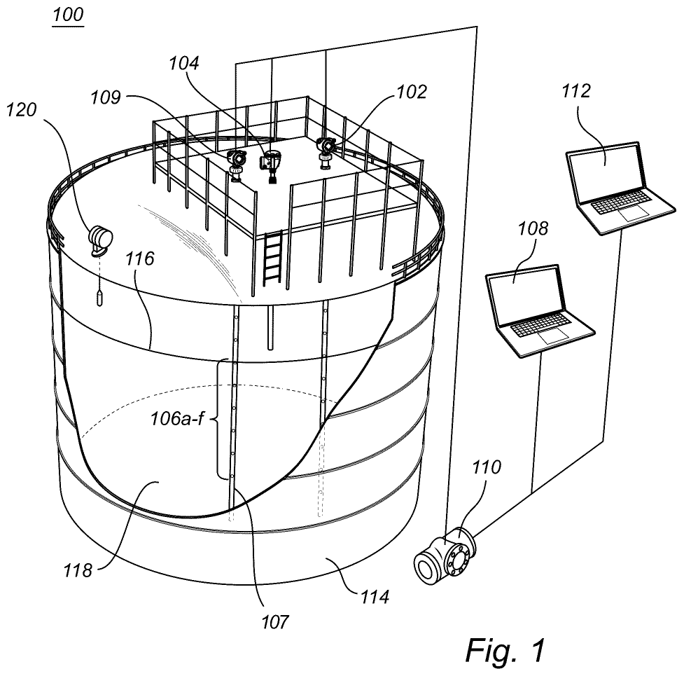

FIG. 1 schematically illustrates an example embodiment of a field device system 100 configured to determine properties of a product 118, here LNG, in a storage tank 114. The field device system 100 comprises a fill level sensor 102 configured to determine a fill level 116 of a product 118 in a tank 114, a pressure sensor 104 configured to determine a pressure in the tank 114, and a plurality of temperature sensors 106a-f each arranged to determine a temperature in the tank 114. The plurality of temperature sensors 106a-f are arranged on a probe 107 here illustrated having a probe head 109. The temperature sensors 106a-f are distributed along the length of the probe 107, preferably with a distance between adjacent sensors not exceeding 1 meter.

The field device system 100 further comprises a Level-Temperature-Density (LTD) sensor 120, sometimes referred to as an LTD-gauge 120. An LTD-sensor 120 is commonly provided in the form of a sensor arranged at the end of a wire so that the sensor can be lowered into the tank to measure the density at multiple locations in the tank, thereby acquiring a density profile.

It should be noted that a field device system for an LNG tank often comprise a number of additional field devices and sensors, but that the present description will focus on the components required for performing proof testing of a rollover detection system. Moreover, the functionality of the field device system will be described with reference to a sensor arrangement comprising a plurality of temperature sensors 106a-f configured to acquire a temperature. However, the described functionality of simulating measurement values and proof testing a rollover detection system is equally applicable for an LTD-sensor 120 configured to provide a density profile. The sensor arrangement may thereby comprise one or both of the plurality of temperature sensors 106a-f and the LTD-sensor 120. Accordingly, where it is described that a temperature sensor is used, temperature values are simulated, or a temperature profile is determined or simulated, temperature and density is in principle interchangeable. The selection of which values are simulated are determined by the required input of the rollover detection system and by the availability of sensors in the field device system, and it is possible to simulate either or both of a temperature and density profile.

The field device system 100 further comprises a proof testing control unit 108 configured to provide simulated temperature values for the plurality of temperature sensors 106a-f, the simulated temperature values being indicative of stratification of the product in the tank 114, and a system hub 110 configured to acquire a fill level 116 of the product 118 in the tank 114, optionally a pressure in the tank 114, and the simulated temperature values from the plurality of temperature sensors 106a-f. The fill level 116 of the tank can be determined by the fill level sensor 102 and the pressure in the tank 114 can be determined by the pressure sensor 104 which are both connected to the system hub 110. The system hub 110 is configured to connect and communicate with the different components of the field device system 100. Even though the system hub 110 is illustrated as a single component, the described functionality of the system hub 100 may equally well be distributed over several separate components, in particular in large field device systems comprising many devices. Moreover, in some cases redundancy may be desirable in which case several systems hubs 110 or similar devices may be arranged to operate in parallel. A system hub 110 may also be referred to and/or interchangeable with a so called tank hub.

The system hub 110 is configured to provide the fill level, the pressure, and the simulated temperature values to a rollover evaluation unit 112. The rollover evaluation unit 112 is then responsible for determining if the current conditions in the tank are indicative of a coming rollover event. For example, rollover evaluation unit 112 can estimate the number of days to an expected rollover event and the consequences of such an event based on current (simulated) stratification of the product in the tank.

The system hub 110 finally receives an output from the rollover evaluation unit 112 indicative of a risk of rollover in the tank based on the fill level, pressure and the simulated temperature values. If rollover is anticipated, appropriate measures for breaking up the stratification to avoid rollover can be taken.

Moreover, the described rollover evaluation unit 112 is preferably part of an overall rollover protection system which may comprise additional components and functions, such as alarm functions and tank control functionality. However, such additional features are known to the skilled person and will not be discussed in the present disclosure.

Each of the proof testing control unit 108, system hub 110 and the rollover evaluation unit 112 comprises processing circuitry configured to provide at least the functionality described herein. The processing circuitry may include a microprocessor, microcontroller, programmable digital signal processor or another programmable device. The processing circuitry may also, or instead, include an application specific integrated circuit, a programmable gate array or programmable array logic, a programmable logic device, or a digital signal processor. Where the processing circuitry includes a programmable device such as the microprocessor, microcontroller or programmable digital signal processor mentioned above, the processor may further include computer executable code that controls operation of the programmable device.

The rollover evaluation unit 112 may for example be a stationary or portable computer comprising the appropriate software for evaluating the risk of rollover, such as in commercially available rollover evaluation software. It is also possible to implement the functionality of both the proof testing control unit 108 and the rollover evaluation unit 112 in the same hardware unit, such as a computer. Moreover, a computer comprising the described functionality of the proof testing control unit 108 and the rollover evaluation unit 112 may also comprise other tank monitoring and control software.

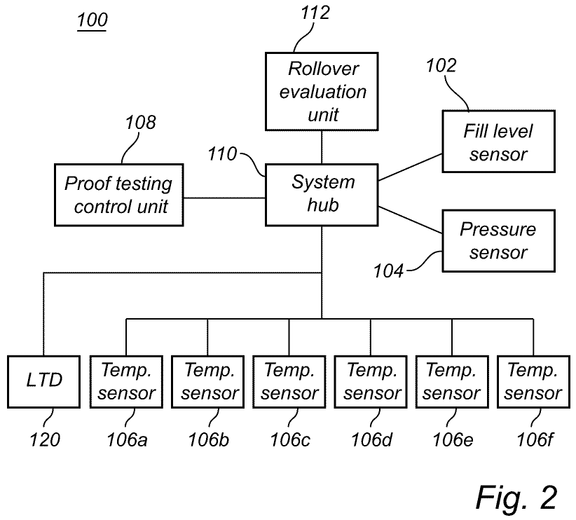

FIG. 2 is a block diagram schematically outlining the components of a field device system comprising the fill level sensor 102, the pressure sensor 104, the proof testing control unit 108, the system hub 110, the rollover evaluation unit 112, an LTD-sensor 120 and a plurality of temperature sensors 106a-f.

The proof testing control unit 108 may be configured to either provide simulated temperature values directly to the plurality of temperature sensors 106a-f such that the system hub 110 acquires the simulated temperature values from the plurality of temperature sensors 106a-f, or the proof testing control unit 108 may communicate simulated temperature values for the plurality of temperature sensors 106a-f directly to the system hub 110. In the first scenario where the output of the temperature sensors 106a-f is controlled, the full communication route between the temperature sensors 106a-f and system hub 110, and further to the rollover evaluation unit 112 is tested. In the second scenario where the simulated temperature values are provided directly to the system hub 110, it is not required that the system hub 110 communicates with the temperature sensors 106a-f.

Moreover, FIG. 2 illustrates the rollover evaluation unit 112 as being connected to both the proof testing control unit 108 and to the system hub 110 meaning that the rollover evaluation unit 112 can be configured to communicate with either of the proof testing control unit 108 and the system hub 110 separately, or with both units.

In an example embodiment, the fill level sensor 102 is configured to perform a level measurement to determine a level of the product 118 in the tank 114. The fill level 116 can then be provided to the proof testing control unit 108 to determine which of the plurality of temperature sensors are located in the product. The simulated temperature values can then be set to be indicative of stratification in the tank for the temperature sensors located in the product. Temperature sensors located above the fill level can then be disregarded by the rollover software.

The field device system 100 may also be configured to measure the pressure in the tank by the pressure sensor 104 since the rollover evaluation software typically requires a pressure to determine a risk of rollover. A cooled LNG-tank generally operates at atmospheric pressure which can then be verified and provided to the rollover evaluation unit 112.

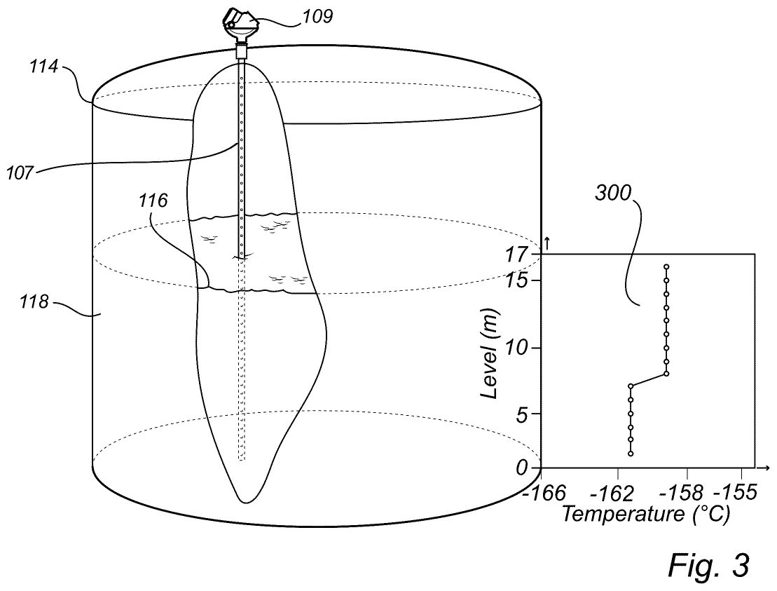

FIG. 3 schematically illustrates a probe 107 comprising a plurality of temperature sensors arranged in the tank 114. FIG. 3 also illustrates a temperature profile 300 of LNG where it can be seen that the temperature of the product 118 changes at a certain level in the tank 114, which is indicative of stratification of the product. As illustrated in FIG. 3, the colder product is at the bottom of the tank and the warmer product at the top of the tank. However, there are in principle no specific temperatures which are required to indicate stratification, it is primarily the identification of different layers having different temperatures which indicate a stratification in the tank. A simulated temperature profile indicative of stratification can thereby be set manually by a user with relative ease.

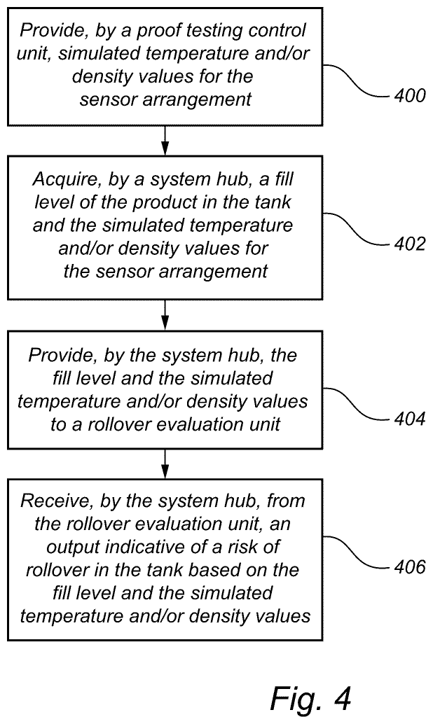

FIG. 4 is a flow chart outlining steps of a method according to an example embodiment of the invention performed by the above described field device system 100. The method first comprises providing 400, by the proof testing control unit 108, simulated temperature and/or density values for the sensor arrangement, where the simulated temperature and/or density values are indicative of stratification of a product in the tank.

Next, the system hub 110 acquires 402 a fill level 116 of the product 118 in the tank 114 and the simulated temperature and/or density values for the sensor arrangement, and provides 404 the fill level and the simulated temperature and/or density values to the rollover evaluation unit 112.

Finally, the system hub receives 406, from the rollover evaluation unit 118, an output indicative of a risk of rollover in the tank based on the fill level and the simulated temperature and/or density values.

The method may further comprise setting the field device system in a simulation mode where components and control units of the field device system is made aware of that a simulation is running, or at least that simulated temperature and/or density values are used. The simulation mode can be used to suppress alarms or other notifications which may otherwise be triggered based on the simulated values. Once the proof test procedure is completed, the field device system can enter a normal operating mode.

Even though the invention has been described with reference to specific exemplifying embodiments thereof, many different alterations, modifications and the like will become apparent for those skilled in the art. Also, it should be noted that parts of the system and method may be omitted, interchanged or arranged in various ways, the system and method yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A method of proof testing a rollover detection system in a field device system comprising a fill level sensor for determining a fill level of a product in a tank, and a sensor arrangement configured to determine at least one of temperature and density at multiple locations in the tank, the method comprising:
by a proof testing control unit, providing simulated temperature and/or density values for the sensor arrangement, the simulated temperature and/or density values being indicative of stratification of a product in the tank;
by a system hub, acquiring a fill level of the product in the tank, and the simulated temperature and/or density values for the sensor arrangement, and providing the fill level, and the simulated temperature and/or density values to a rollover evaluation unit; and
by the system hub, receiving, from the rollover evaluation unit, an output indicative of a risk of rollover in the tank resulting from the fill level and the simulated temperature and/or density values.

2. The method according to claim 1, wherein the sensor arrangement comprises a plurality of temperature sensors spaced apart in the tank.

3. The method according to claim 2, wherein providing simulated temperature values indicative of stratification of a product in the tank comprises, by the proof testing control unit, providing a simulated temperature value to each of the plurality of temperature sensors; and
by the system hub, acquiring the simulated temperature values from the plurality of temperature sensors.

4. The method according to claim 2, further comprising controlling each temperature sensor to only send a simulated temperature value to the system hub.

5. The method according to claim 2, wherein providing simulated temperature values indicative of stratification of a product in the tank comprises, by the proof testing control unit, sending simulated temperature values for the plurality of temperature sensors to the system hub.

6. The method according to claim 2, further comprising:
determining a level of the product in the tank;
determining which of the plurality of temperature sensors are located in the product; and
setting temperature values indicative of stratification in the tank for the temperature sensors located in the product.

7. The method according to claim 1, further comprising setting the field device system in a simulation mode.

8. The method according to claim 1, further comprising, by a pressure sensor arranged in the tank, determining a pressure in the tank and providing the determined pressure to the rollover evaluation unit.

9. The method according to claim 1, wherein the sensor arrangement comprises an LTD, Level Temperature Density, profiling sensor.

10. A computer program product comprising program code for performing, when executed by a processor device, the method of claim 1.

11. A non-transitory computer-readable storage medium comprising instructions, which when executed by a processor device, cause the processor device to perform the method of claim 1.

12. A field device system comprising:
a fill level sensor configured to determine a fill level of a product in a tank;
a sensor arrangement arranged to determine at least one of a temperature and a density at multiple locations in the tank;
a proof testing control unit configured to provide simulated temperature and/or density values for the sensor arrangement, the simulated temperature and/or density values being indicative of stratification of the product in the tank; and
a system hub configured to: acquire a fill level of the product in the tank and the simulated temperature and/or density values for the sensor arrangement, provide the fill level and the simulated temperature and/or density values to a rollover evaluation unit; and receive, from the rollover evaluation unit, an output indicative of a risk of rollover in the tank based on the fill level, and the simulated temperature and/or density values.

13. The field device system according to claim 12, wherein the sensor arrangement comprises a plurality of temperature sensors spaced apart in the tank.

14. The field device system according to claim 13, wherein a vertical distance between adjacent temperature sensors is lower than or equal to 1 meter.

15. The field device system according to claim 13, wherein the proof testing control unit is configured to provide simulated temperature values to the plurality of temperature sensors, and the system hub is further configured to acquire the simulated temperature values from the plurality of temperature sensors.

16. The field device system according to claim 13, wherein the proof testing control unit is configured to send simulated temperature values for the plurality of temperature sensors to the system hub.

17. The field device system according to claim 13, wherein the fill level sensor is configured to perform a level measurement to determine a level of the product in the tank; and wherein the proof testing unit is configured to determine which of the plurality of temperature sensors are located in the product, and to set temperature values indicative of stratification in the tank for the temperature sensors located in the product.

18. The field device system according to claim 13, wherein the plurality of temperature sensors are arranged on a probe and distributed along the length of the probe.

19. The field device system according to claim 12, further comprising a pressure sensor arranged in the tank, the pressure sensor being configured to determine a pressure in the tank and to provide the determined pressure to the rollover evaluation unit.

20. The field device system according to claim 12, wherein the sensor arrangement comprises an LTD, Level Temperature Density, profiling sensor.
